(19) United States
(12) Patent Application Publication
(10) Pub. No.: US 2007/0147792 A1
(43) Pub. Date: Jun. 28, 2007

(54) Moving picture playback equipment and moving picture playback method

(75) Inventors: Toshikazu Mochizuki, Tokyo (JP); Yuichi Togashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/637,163

(22) Filed: Dec. 12, 2006

(30) Foreign Application Priority Data
Dec. 27, 2005 (JP) 2005-375163

(51) Int. Cl. H04N 7/26

(52) U.S. Cl. 386/112

(57) ABSTRACT

According to one embodiment of this invention includes a disc drive section which reads compressed video information and management information from a recording medium. The management information contains resolution information obtained when the compressed video information is decoded. Digital-to-analog converters subjects the video information decoded by the decoder sections to digital-to-analog conversion. A management information determining section contains a resolution determining section which determines resolution of the decoded video information with reference to management information. A decode mode setting section sets the decoder sections and digital-to-analog converters into a processing mode suitable for the resolution based on the determination result of the resolution determining section.

### CROSS-REFERENCE TO RELATED APPLICATIONS

This application is based upon and claims the benefit of priority from Japanese Patent Application No. 2005-375163, filed Dec. 27, 2005, the entire contents of which are incorporated herein by reference.

### BACKGROUND

1. Field

One embodiment of the invention relates to moving picture playback equipment and a moving picture playback method and more particularly to the improvement of a decoding process.

2. Description of the Related Art

In recent years, CD players having Moving Picture coding Experts Group 1 (MPEG1) decoding functions have tended to be developed. In the above CD player, moving picture data and voice data recorded in a digital compressed form on a video CD (VCD) can be played back. Further, recently, players having Moving Picture coding Experts Group 2 (MPEG2) decoding functions have been developed and can decode and play back a China Video CD (CVD) or Super Video CD (SVCD) having a higher quality than the conventional CD. In addition, Digital Versatile Disc (DVD) players having MPEG2 decoding functions have been commercialized mainly in Japan and the U.S.A. By use of the DVD player, a video image with a resolution of 720 dots and 480 lines can be displayed.

Since contents of various systems are provided as described before, it is necessary to perform the data playback process by switching the operation modes according to the respective systems in the player. As a device which realizes the above player, a device disclosed in Patent Document 1 is provided.

The device reads a sequence header recorded on an optical disc, determines one of a VCD, SVCD and DVD which corresponds to the optical disc and determines whether recorded video information is a Phase Alternation by Line (PAL) system or National Television Standards Committee (NTSC) system. Then, the decoding process is performed with adequate resolution according to the determination result.

[Patent Document 1] Jpn. Pat. Appln. KOKAI Publication No. 2001-186454:

In the above device, it is supposed that the contents recorded on one disc are based on one standard and the resolution of the recorded contents (video information) is constant. Therefore, the playback equipment outputs an output signal with the resolution thereof forcedly set at a constant value. For example, the output signal is output with the initially set resolution according to the resolution of the display device connected thereto.

However, in recent years, a standard called High Definition (or High Density) DVD (HD DVD) DVD has been completed and new types of discs (HD DVDs) have been developed. In HD DVD, plural types of contents can be provided together. Therefore, contents with different resolutions are alternately played back in some cases and, at the same time, the contents may be played back in a picture-in-picture state. In this case, when the player is set to always output information with constant resolution, the user is forced to change the resolution by setting the on/off state of an up-converter, for example, while watching the display device. However, the above operation is troublesome for the user and the user must pay much attention to the resolution each time discs are exchanged.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of a moving picture playback equipment according to one embodiment of this invention.

FIG. 2 is a diagram for illustrating one example of the structure of data stored in a recording medium.

FIG. 3 is a diagram for illustrating one example of the configuration of management information shown in FIG. 2.

FIG. 4 is a block diagram showing one example of a function contained in an MPU of the moving picture playback equipment shown in FIG. 1.

FIG. 5 is a flowchart showing one example of a resolution determining process performed in a management information determining section shown in FIG. 4.

FIG. 6 is an explanatory view showing one example of a display example in which the state of resolution of the disc played back is displayed.

FIG. 7 is a block diagram showing one example of the configuration of a video-series decoder and video processor section shown in FIG. 1.

FIG. 8 is a block diagram showing one example of the configuration of an audio decoder section shown in FIG. 1.

### DETAILED DESCRIPTION

Various embodiments according to the invention will be described hereinafter with reference to the accompanying drawings.

In one embodiment of this invention, an object is to provide a moving picture playback equipment and moving picture playback method which can automatically recognize the resolution of recorded video information, automatically perform a decoding process with adequate resolution and display a value of the output resolution when a DVD or HD DVD is played back.

In order to achieve the above object, a moving picture playback equipment in one embodiment of this invention includes a disc drive section 101 which reads compressed video information and management information from a recording medium on which the compressed video information and the management information containing resolution information obtained when the compressed video information is decoded are recorded, decoder sections 111, 112, 113, 114 which decode the compressed video information read out by the disc drive section, digital-to-analog converters 132, 133 which subject the video information decoded by the decoder sections to digital-to-analog conversion, a management information determining section 121b containing a resolution determining section 121b2 which determines resolution of the decoded video information with reference to management information read by the disc drive section, and a decode mode setting section 121c which sets the decoder sections and digital-to-analog converters into a processing mode suitable for the resolution based on the determination result of the resolution determining section.

By the above embodiment, it is possible to decode and output the contents with original resolution recorded on a DVD or HD DVD and fully exhibit the ability of the display device irrespective of the user's intention and the user can easily get information on the resolution of an output signal.

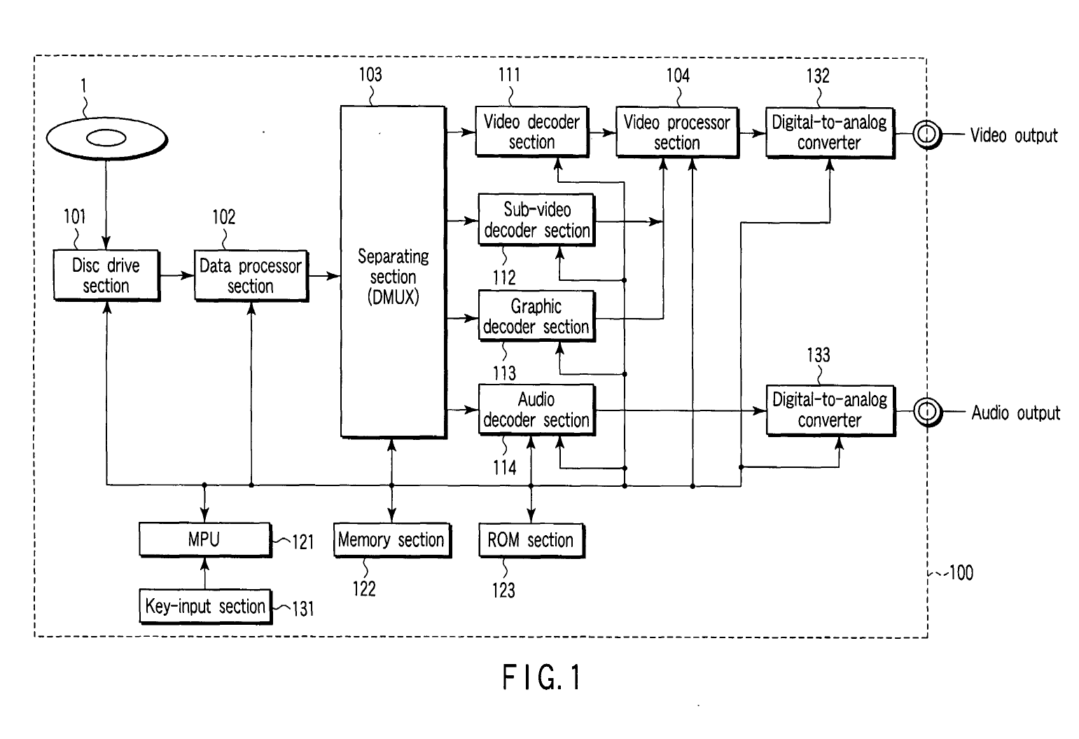

Next, the moving picture playback equipment and moving picture playback method according to one embodiment of this invention are explained with reference to the accompanying drawings. FIG. 1 is an exemplary block diagram showing an example of the configuration of a moving picture playback equipment 100 according to one embodiment of this invention.

<Configuration and Function>

In FIG. 1, a reference symbol 1 denotes a recording medium (optical disc) which is loaded on a disc drive section 101. A data processor section 102 is connected to the output portion of the disc drive section 101. A separating section 103 which is a demultiplexer (DMUX) is connected to the output portion of the data processor section 102.

The recording medium 1 is an optical disc on which video information (a video object which generally indicates video data, sub-video (sub-picture) data, voice data) is recorded. The disc drive section 101 reads video information recorded on the disc 1 and management information relating to the video information. The data processor section 102 performs the demodulation process and error correction process for information read by the disc drive section 101. Further, data thus subjected to the error correction process is stored in a track buffer in the data processor section 102.

The separating section 103 separates video information into a video pack, graphic unit pack, audio pack and sub-video pack. A video decoder section 111, sub-video decoder 112, graphic decoder section 113 and audio decoder section 114 are connected to the output portion of the separating section 103. The output terminals of the video decoder section 111, sub-video decoder 112 and graphic decoder section 113 are connected to a video processor 104. The output terminal of the video processor section 104 is connected to the digital-to-analog converter 132. The output terminal of the digital-to-analog converter 132 is connected to a display device (not shown). Further, the output terminal of the audio decoder section 114 is connected to the digital-to-analog converter 133. The output terminal of the digital-to-analog converter 133 is connected to a speaker (not shown).

The video decoder section 111 decodes a video pack to acquire video data. The sub-video decoder 112 decodes a sub-video pack to acquire sub-video data. The graphic decoder section 113 decodes a graphic unit pack and the audio decoder section 114 decodes an audio pack. The video processor section 104 multiplexes decoded video data and sub-video data. The digital-to-analog converters 132, 133 convert digital video information into an analog form.

Further, the respective sections of the moving picture playback equipment 100 are connected to a microprocessor unit (MPU) 121 via a bus. The MPU 121 is connected to a key-input section 131. Further, the MPU 121 is connected to a memory section 122 and ROM section 123 via a bus.

The MPU 121 generally controls the respective blocks of the equipment. In the memory section 122, management information relating to video information is stored. In the ROM section 123, software or the like used to operate the moving picture playback equipment 100 is stored. The key-input section 131 is used to convert an operation input from the exterior to a control signal.

<Operation>

When a recording medium 1 is connected to the disc drive section 101, the disc drive section 101 rotates and drives the recording medium 1 loaded thereon and reads out information stored in the recording medium 1 by use of an optical pickup (not shown).

Video information read by the disc drive section 101 is demodulated in the data processor section 102, subjected to the error correction process and then stored into the track buffer in the data processor section 102. Management information relating to the video information among the information stored in the track buffer is recorded in the memory section 122 and used for playback control, data management and the like. Video information stored in the track buffer is supplied to the separating section 103 and separated into a video pack, graphic unit pack, audio pack and sub-video pack.

The thus separated video pack, sub-video pack, graphic unit pack and audio pack are respectively supplied to the video decoder section 111, sub-video decoder section 112, graphic decoder section 113 and audio decoder section 114 and subjected to the corresponding decoding processes.

The decoded video data, sub-video data and graphic data are supplied to the video processor 104 and subjected to multiple processing. Video information subjected to the multiple processing is supplied to the digital-to-analog converter 132 and converted into a video analog signal which can be displayed on the display section. The video analog signal is supplied to the display section and the video signal is displayed thereon.

Further, the decoded audio pack is supplied to the digital-to-analog converter 133 and converted into a voice analog signal which can be played back by use of a speaker. The voice analog signal is supplied to the speaker and the voice is played back.

Each decoder is shown as one unit, but in practice, decoders (player sections) which are operated to cope with various standards (such as DVD, HD DVD) are prepared. Then, video, audio and sub-video processing sections are operated according to a disc with a standard to be played back.

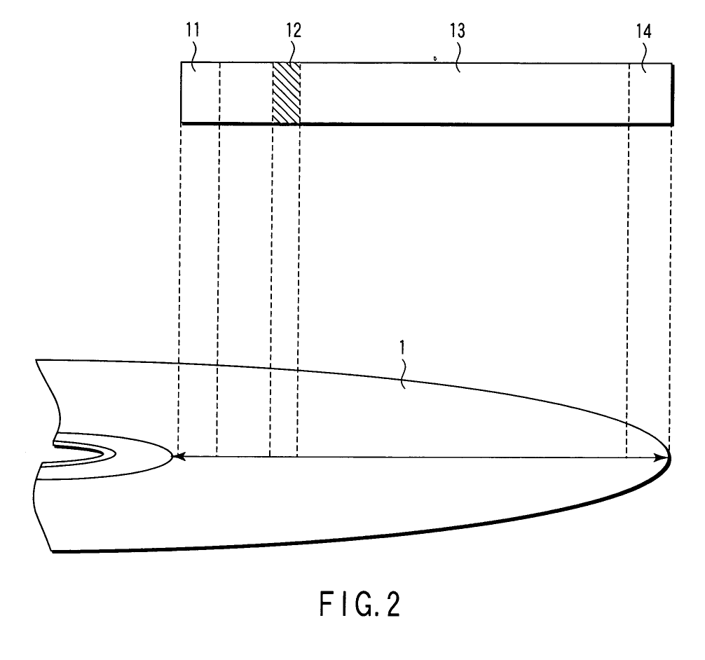

FIG. 2 is a diagram showing one example of the structure of data stored in the recording medium 1. In the recording medium 1 which is an optical disc, at least one set of a lead-in area 11 and lead-out area 14 is set. Further, a data area 13 in which data is stored and management information 12 required for playing back data stored in the data area 13 are recorded. The lead-in area 11, management information 12, data area 13 and lead-out area 14 are sequentially arranged from the inner portion of the disc. When data in the data area 13 is divided into a plurality of titles, the management information 12 may be arranged for each title in some cases.

That is, the operation of reading out data in the recording medium 1 is started from the lead-in area 11. Next, the storage location of desired data is determined by use of the management information 12. Then, the desired data in the data area 13 is accessed.

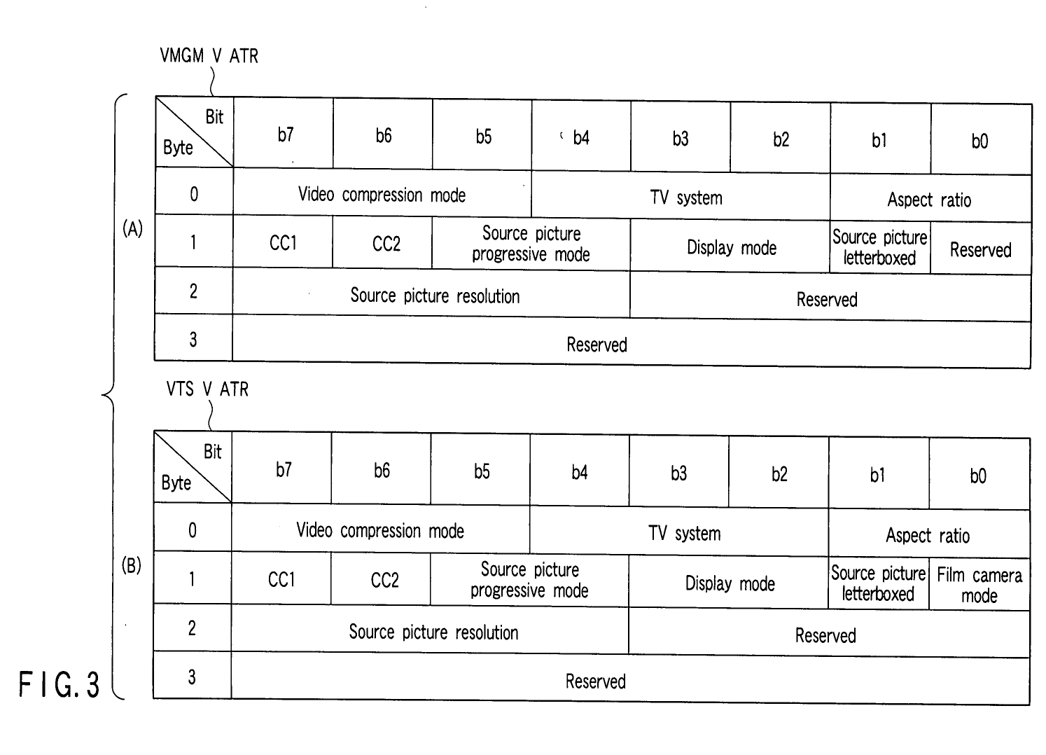

FIGS. 3A and 3B are diagrams showing one example of the configuration of the management information 12 shown in FIG. 2. VMGM V ATR (FIG. 3A) is information indicating the video attribute among the management information of the whole portion of the recording medium 1. Further, VTS V ATR (FIG. 3B) is information indicating the video attribute among the management information of each title.

“Video compression mode” is information indicating a data compression system (such as MPEG2). “TV system” is information indicating a television system and indicates an NTSC, PAL or SECAM system. “Aspect ratio” is information indicating a display angle of view (for example, 16:9 or 4:4). “CC1”, “CC2” are information items of closed captions. “Source picture Progressive mode” is information indicating identification of the interlace system and non-interlace system. “Display mode” is information indicating whether or not the pan scan display or letterbox display can be performed. “Source picture letterboxed” is information indicating whether output video is a letterbox or not. “Reserved” is spare space capacity. “Source picture resolution” indicates the resolution. “Film camera mode” is information indicating whether a film mode is set or not.

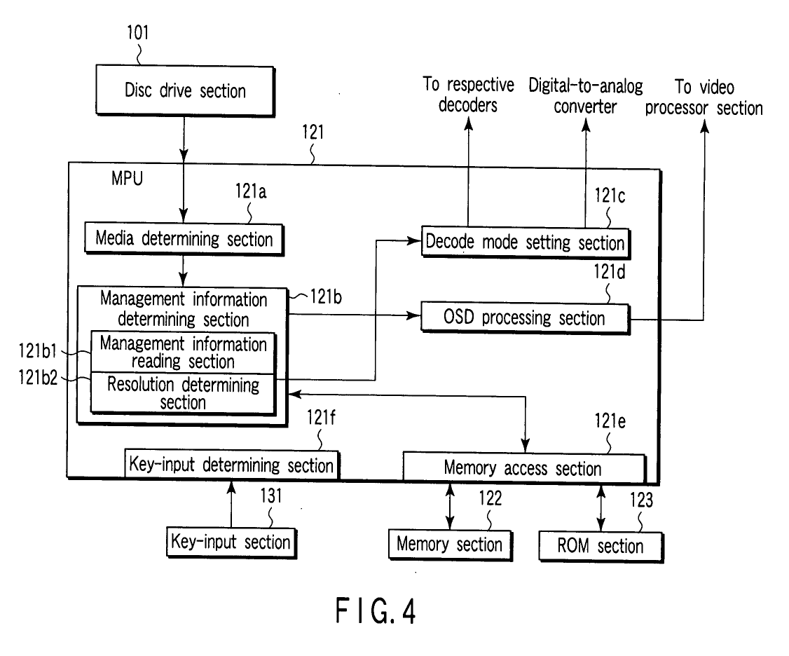

FIG. 4 is a block diagram showing one example of a functioning section contained in the MPU 121 shown in FIG. 1. The MPU 121 includes a media determining section 121a. The media determining section 121a determines the type of an optical disc loaded in the disc drive section 101.

As a method for determining the type of an optical disc, the following method is provided. That is, when a first light source is used in the optical pickup device, the wavelength is set at 650 nm and NA is set at 0.65, then the following state is attained. When a focus error signal is set at “0”, the in-focus state is attained. In this state, if the objective lens is moved back and forth (moved in the thickness direction of the disc), the characteristic indicating an “S”-shaped curve is attained. At this time, the maximum value MAX exceeds a threshold value Th1 when the disc is a DVD or HD DVD. When the disc is a CD, it does not exceed the threshold value Th1.

Further, when a second light source is used in the optical pickup device, the wavelength is set at 405 nm and NA is set at 0.65, then the following state is attained. The maximum value MAX of an S-shaped curve exceeds a threshold value Th2 when the disc is a DVD or HD DVD. When the disc is a CD, it does not exceed the threshold value Th1.

Thus, it is possible to determine that the disc is a DVD or HD DVD, or CD or another disc. If it is determined that the disc is a DVD or HD DVD, whether the disc is a DVD or HD DVD can be determined by determining a tracking error signal. For example, if the first light source (wavelength 650 nm) is used and NA is set at 0.65, the tracking error signal is converged when the disc is a DVD. On the other hand, if the second light source (wavelength 405 nm) is used and NA is set at 0.65, the tracking error signal is converged when the disc is an HD DVD. By using this phenomenon, whether the disc is a DVD or HD DVD can be determined.

The MPU 121 has a management information determining section 121b. The management information determining section 121b has a management information reading section 12b1 and resolution determining section 121b2. The management information reading section 12b1 acquires the management information 12 by use of the disc drive section 101. Further, it reads and stores the management information 12 in the memory section 122 via a memory access section 121e. Also, the memory access section 121e is connected to the ROM section 123 and information stored therein can be read. Further, the resolution determining section 121b2 determines the resolution of video information (video information to be subjected to the decode process) contained in the loaded recording medium 1 based on the management information 12.

Also, the MPU 121 has a decode mode setting section 121c. The decode mode setting section 121c sets the processing modes of the various decoders and digital-to-analog converters according to the determination result of the resolution determining section 121b2. For example, it sets a sampling frequency.

Further, the MPU 121 has an on-screen display (OSD) processing section 121d. The OSD processing section 121d displays the determination result of the management information determining section 121b and other processing results by use of, for example, character codes in the equipment. The display location may be set at a display device connected to the equipment or a display section provided on the equipment main body.

The MPU 121 has a key-input determining section 121f. The key-input determining section 121f controls the corresponding sections to reflect the operation input to the key-input section 131 on the respective sections.

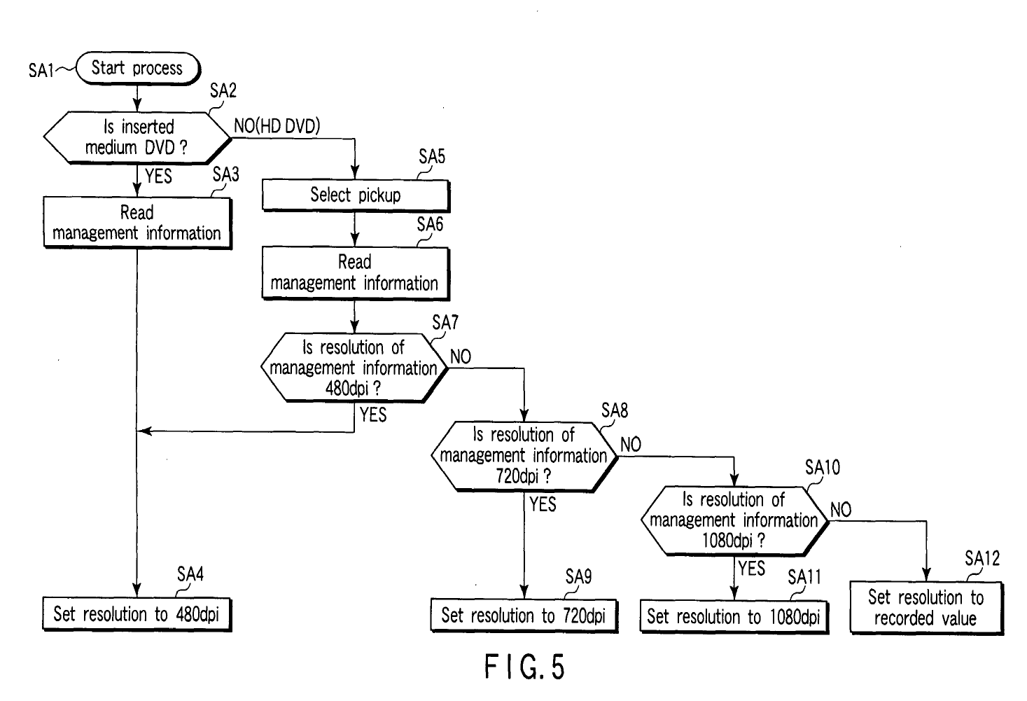

FIG. 5 is a flowchart showing one example of a resolution determining process performed by the management information determining section 121b shown in FIG. 4. When a recording medium 1 is loaded or when the power supply of the equipment main body is turned ON while the recording medium 1 is loaded (step SA1), the type of the recording medium 1 loaded is determined in the media determining section 121a (step SA2). If the loaded recording medium 1 is a DVD, the management information 12 is read (step SA3). Then, the fact that the resolution is 480 dots is set in the decode mode setting section 121c (step SA4).

If it is detected in the step SA2 that the loaded recording medium 1 is not a DVD but an HD DVD, the optical pickup is set to an optical pickup for HD-DVD (step SA5). Then, the management information 12 is read out (step SA6) and whether the resolution of the data is 480 dots or not is determined based on the management information 12 read by the resolution determining section 121b2 (step SA7). If the resolution is 480 dots, the process returns to step SA4 and the fact that the resolution is 480 dots is set in the decode mode setting section 121c.

However, if it is determined in the step SA7 that the resolution is not 480 dots, whether the resolution of the data is 720 dots or not is determined (SA8). If the resolution is 720 dots, the fact that the resolution is 720 dots is set in the decode mode setting section 121c (SA9).

If it is determined in step SA8 that the resolution is not 720 dots, whether the resolution of the data is 1080 dots or not is determined (SA10). If the resolution is 1080 dots, the fact that the resolution is 1080 dots is set in the decode mode setting section 121c (SA1).

If it is determined in step SA10 that the resolution is not 1080 dots, the value of “Source picture resolution” of the management information 12 is set as it is in the decode mode setting section 121c (SA12).

Therefore, with the above equipment, the decode mode is set in a form corresponding to the resolution with which data is recorded on the disc.

In the above explanation, the management information determining section 121b has the on-screen display processing section 121d and the on-screen display processing section 121d outputs display information with the resolution determined by the resolution determining section 121b2 to the video processor section 104. When display information of the resolution is output to the video processor section 104, it is displayed together with video information on the display device used as a monitor.

However, this invention is not limited to this case and the on-screen display processing section 121d may display information with the resolution determined by the resolution determining section 121b2 on a display provided on the equipment main body.

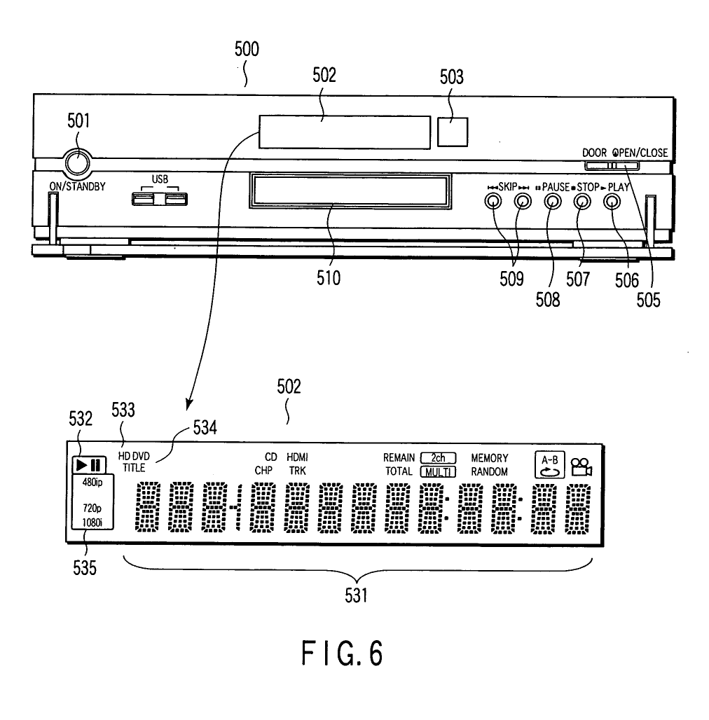

FIG. 6 is a front view of an information playback equipment 500. A reference symbol 501 denotes a power supply on/off button and 502 indicates a display window corresponding to the display section 134. Further, 503 denotes a remote control receiving section and 505 denotes a door open/close button. A reference symbol 506 denotes a playback operation button, 507 a stop operation button, 508 a pause operation button, and 509 a skip operation button. Further, a reference symbol 510 denotes a disc tray, and when the door open/close button 505 is operated, the disc tray protrudes or retracts and thus discs can be exchanged.

In the display window 502, a segment display section 531 is provided and the total playback time, elapse time, remaining amount, title and the like of the disc can be displayed. Further, in a state display section 532, the playback operation, stop operation or pause operation can be displayed. Further, a disc identification display section 533 is provided and the type of a disc (DVD, HD DVD or the like) loaded thereon can be displayed. A title display section 534 is provided to display the title number. On a display section 535, the degree of resolution of video data now output can be displayed. That is, 480ip, 720p or 1080p is set in the lighted state according to the determined resolution.

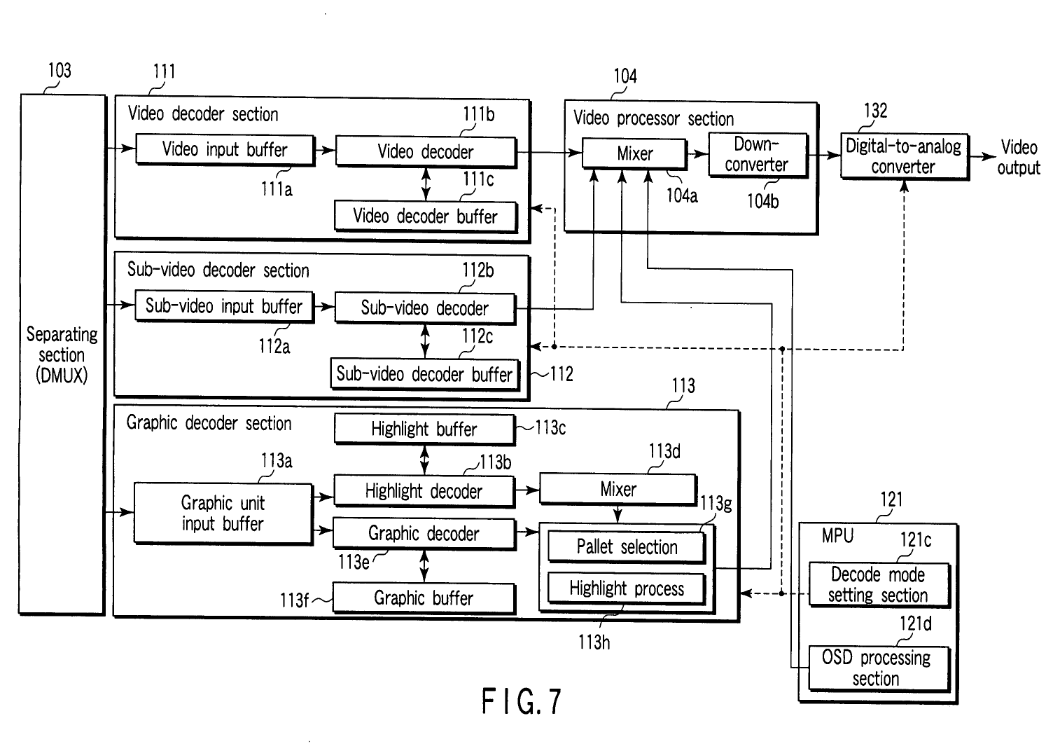

FIG. 7 is a block diagram showing one example of the configuration of the video-series decoder and video processor section 104 shown in FIG. 1. The video decoder section 111 is supplied with a video pack separated by the separating section 103. The video decoder section 111 is configured by a video input buffer 111a, video decoder 111b and video decoder buffer 111c. Video data decoded in the video decoder 111b is supplied to a mixer 104a of the succeeding-stage video processor 104.

The sub-video decoder section 112 is supplied with a sub-video pack separated by the separating section 103. The sub-video decoder section 112 is configured by a sub-video input buffer 112a, sub-video decoder 112b and sub-video decoder buffer 112c. Sub-video data decoded by the sub-video decoder 112b is fed to the mixer 104a of the succeeding-stage video processor 104.

The graphic decoder section 113 is supplied with a graphic unit pack separated by the separating section 103. The graphic decoder section 113 is configured by a graphic unit input buffer 113a which buffers the graphic unit pack supplied thereto and can store at least one graphic unit, a highlight decoder 113b which decodes highlight information and mask data of the graphic unit stored in the input buffer 113a, a highlight buffer 113c thereof, a graphic decoder 113e which decodes graphic data of the graphic unit stored in the input buffer 113a, and a graphic buffer 113f thereof. Further, a button pattern decoded by the highlight decoder 113b is mixed with graphic data decoded by the graphic decoder 113e in a succeeding-stage mixer 113d and supplied to the mixer 104a of the video processor 104 after being subjected to pallet selection 113g and highlight process 113h.

In this case, the decode mode setting section 121c of the MPU 121 is connected to the control terminals of the video decoder section 111, sub-video decoder section 112 and graphic decoder section 113. For example, the sampling frequency at the time of the decode process is set by the decode mode setting section 121c of the MPU 121. Input video information can be decoded with its own resolution by setting the sampling frequency to a low frequency (Low) with 480 dots, a middle frequency (Middle) with 720 dots and a high frequency (High) with 1080 dots.

Various processing results are supplied to the mixer 104a of the video processor section 104 by the OSD processing section 121d as message data by use of character codes contained therein. The mixer 104a superimposes the supplied video data, sub-video data, graphic data and message data. When the display section is a standard television (SDTV), the superimposed video data is down-converted to have resolution of the display section by a down-converter 104b and then output to the digital-to-analog converter 132.

The digital-to-analog converter 132 performs the digital-to-analog conversion operation based on the sampling frequency set by the decode mode setting section 121c and outputs a video analog signal to the display section.

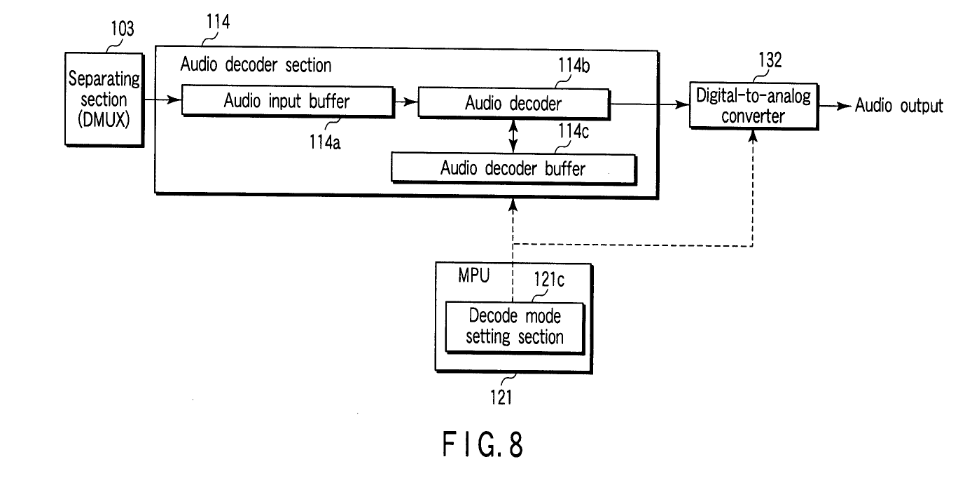

FIG. 8 is a block diagram showing one example of the configuration of the audio-series decoder shown in FIG. 1. The audio decoder section 114 is supplied with an audio pack separated by the separating section 103. The audio decoder section 114 is configured by an audio input buffer 114a, audio decoder 114b and audio decoder buffer 114c. Audio data decoded by the audio decoder 114b is output to the succeeding-stage digital-to-analog converter 133.

Also, in this case, the decode mode setting section 121c of the MPU 121 is connected to the control terminal of the audio decoder section 114. That is, the sampling frequency at the time of the decode process is set by the decode mode setting section 121c of the MPU 121. For example, the sampling frequency is set to a low frequency (Low) with 480 dots, a middle frequency (Middle) with 720 dots and a high frequency (High) with 1080 dots.

The digital-to-analog converter 133 performs the digital/analog conversion operation based on the sampling frequency set by the decode mode setting section 121c and outputs a voice analog signal to the speaker.

According to the above embodiment, when video information recorded on the recording medium is decoded, the resolution of the video information recorded on the recording medium is determined based on the management information. Then, the decoding operation is performed at the sampling frequency corresponding to the resolution recorded in the management information. Therefore, it is not necessary for the user to set the resolution and it is possible to output video information with adequate resolution.

This invention is not limited to the above embodiment. For example, in this invention, the moving picture playback equipment having the optical pickup is used, but this invention can be easily applied to an equipment which is designed to display video information.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. Moving picture playback equipment comprising:
a disc drive section which reads compressed video information and management information containing resolution information used when the compressed video information is decoded from a recording medium on which the compressed video information and management information are recorded,
a decoder section which decodes compressed video information read out by the disc drive section,
a digital-to-analog converter which subjects video information decoded by the decoder section to a digital-to-analog conversion process,
a management information determining section including a resolution determining section which determines resolution of the video information decoded with reference to the management information read by the disc drive section, and
a decode mode setting section which sets the decoder section and digital-to-analog converter into a processing mode which conforms to the resolution based on a determination result of the resolution determining section.

2. The moving picture playback equipment according to claim 1, wherein the decode mode setting section includes means for changing a sampling frequency of the decoder section and digital-to-analog converter.

3. The moving picture playback equipment according to claim 1, wherein the management information determining section includes a management information reading section.

4. The moving picture playback equipment according to claim 1, wherein the management information determining section includes an on-screen display processing section and the on-screen display processing section outputs display information of resolution determined by the resolution determining section to a video processor section.

5. The moving picture playback equipment according to claim 1, wherein the management information determining section includes an on-screen display processing section and the on-screen display processing section outputs display information of resolution determined by the resolution determining section to a display provided on an equipment main body.

6. A moving picture playback method of equipment including a disc drive section which reads compressed video information and management information containing resolution information used when the compressed video information is decoded from a recording medium on which the compressed video information and management information are recorded, a decoder section which decodes compressed video information read by the disc drive section, and a digital-to-analog converter which subjects video information decoded by the decoder section to a digital-to-analog conversion process, comprising:
causing a control section to determine resolution of the video information to be decoded with reference to management information read by the disc drive section, and
setting the decoder section and digital-to-analog converter into a processing mode which conforms to the resolution based on a determination result of the resolution.

7. The moving picture playback method according to claim 6, wherein the setting of the processing mode is changing a sampling frequency of the decoder section and digital-to-analog converter.

8. The moving picture playback method according to claim 6, wherein display information of resolution based on the determination result of the resolution is output to a video processor section.

9. The moving picture playback method according to claim 6, wherein display information of resolution based on the determination result of the resolution is output to a display provided on an equipment main body.

10. The moving picture playback method according to claim 6, wherein display information of resolution based on the determination result of the resolution is displayed with one of 480 dots, 720 dots and 1080 dots.
